(19) United States
(12) Patent Application Publication
(10) Pub. No.: US 2025/0304445 A1
(43) Pub. Date: Oct. 2, 2025

(54) WASTE GAS TREATMENT DEVICE, WASTE GAS TREATMENT METHOD, AND WASTE GAS ADSORPTION AND RECOVERY SYSTEM INCLUDING THE SAME

(71) Applicant: Samsung Electronics Co., Ltd., Suwon-si (KR)

(72) Inventors: Changhoon Kwak, Suwon-si (KR); Hye Sun Shin, Pohang (KR); Eunsun Hong, Suwon-si (KR); Youngju Ro, Suwon-si (KR); Han Dock Song, Pohang (KR); Joonghoon Lee, Suwon-si (KR); Joonwoo Kim, Pohang (KR); Jiwon Kim, Pohang (KR); Jihyun Kim, Pohang (KR); Cheonwoo Jeong, Pohang (KR); Changho Ha, Pohang (KR)

(73) Assignees: Samsung Electronics Co., Ltd., Suwon-si (KR); Research Institute of Industrial Science & Technology, Pohang-si (KR)

(21) Appl. No.: 19/009,193

(22) Filed: Jan. 3, 2025

(30) Foreign Application Priority Data
Mar. 29, 2024 (KR) 10-2024-0043674

(51) Int. Cl. C01B 23/00; B01D 53/04; B01J 20/04; B01J 20/18; B01J 20/34

(52) U.S. Cl. CPC C01B 23/0068; B01D 53/0423; B01J 20/046; B01J 20/18; B01J 20/3408; B01J 20/3458; B01D 2253/108; B01D 2253/1122; B01D 2257/11; B01D 2258/0216; B01D 2259/40086; C01P 2006/80

(57) ABSTRACT

Provided is a waste gas treatment device including a waste gas inlet configured to introduce waste gas discharged from a semiconductor processing chamber and an adsorption unit configured to adsorb competitive adsorption gas from the waste gas flowing from the waste gas inlet, and configured to adsorb xenon (Xe) from the waste gas from which the competitive adsorption gas has been removed, and recover the adsorbed xenon. Also provided are waste gas treatment methods, and waste gas adsorption and recovery systems including the present waste gas treatment devices.

### CROSS-REFERENCE TO RELATED APPLICATION

This U.S. non-provisional application is based on and claims priority under 35 U.S.C. § 119 to Korean Patent Application No. 10-2024-0043674, filed on Mar. 29, 2024, in the Korean Intellectual Property Office, the disclosure of which is incorporated by reference herein in its entirety.

### BACKGROUND

The inventive concept relates to a waste gas treatment device, a waste gas treatment method, and a waste gas adsorption and recovery system including the same. More specifically, the inventive concept relates to a waste gas treatment device using an adsorbent, a waste gas treatment method, and a waste gas adsorption and recovery system including the same.

Xenon (Xe) is used in semiconductor manufacturing processes, including an etching process. Recently, the amount of xenon used in semiconductor processing is increasing as semiconductor manufacturing processes becomes more advanced. However, xenon (Xe) is classified as a rare gas that exists in a trace amount in the air, and there is a limit in obtaining xenon from the air. Accordingly, there is a problem of limited supply of xenon.

Although xenon is a key material in the etching process, the xenon used in the etching process is currently discharged into the air without separate recovery. Therefore, there is a need to recover xenon included in the waste gas generated after the etching process.

### SUMMARY

The inventive concept provides a waste gas treatment device that selectively adsorbs and recovers xenon from waste gas.

The inventive concept also provides a waste gas treatment method that selectively adsorbs and recovers xenon from waste gas.

The inventive concept provides a waste gas adsorption and recovery system that selectively adsorbs and recovers xenon from waste gas.

The problems to be solved by the technical spirit of the inventive concept are not limited to the problems mentioned herein, and other problems not mentioned will be clearly understood by those skilled in the art from the present description.

According to an aspect of the inventive concept, there is provided a waste gas treatment device including a waste gas inlet configured to introduce waste gas discharged from a semiconductor processing chamber, and an adsorption unit configured to adsorb/remove competitive adsorption gas from the waste gas flowing from the waste gas inlet, and configured to adsorb xenon (Xe) from the waste gas from which the competitive adsorption gas has been removed and recover the adsorbed xenon.

According to an aspect of the inventive concept, there is provided a waste gas treatment method including introducing waste gas discharged from a semiconductor processing chamber into an adsorption unit of a waste gas treatment device, in which the adsorption unit includes one or more first adsorption towers and one or more second adsorption tower. The method includes adsorbing competitive adsorption gas from the waste gas introduced into the adsorption unit, in the one or more second adsorption towers; adsorbing xenon (Xe) from the waste gas from which the competitive adsorption gas is removed, in the one or more first adsorption towers; and desorbing the adsorbed Xe by injecting nitrogen into the one or more first adsorption towers.

According to another aspect of the inventive concept, there is provided a waste gas adsorption and recovery system including a semiconductor processing chamber, a waste gas treatment device including a waste gas inlet configured to introduce waste gas discharged from the semiconductor processing chamber and an adsorption unit configured to adsorb competitive adsorption gas from the waste gas flowing from the waste gas inlet, and configured to adsorb xenon (Xe) from the waste gas from which the competitive adsorption gas has been removed, and desorb adsorbed xenon; and desorb adsorbed xenon, and a recovery unit configured to recover xenon desorbed from the waste gas treatment device, wherein the adsorption unit includes one or more first adsorption towers configured to selectively adsorb Xe from the waste gas and desorb the adsorbed xenon, and the one or more first adsorption tower includes an adsorbent including Ag-ZSM-5 (or Ag-Zeolite Socony Mobil-5 or Ag pentasil-zeolite).

### BRIEF DESCRIPTION OF THE DRAWINGS

Embodiments will be more clearly understood from the following detailed description taken in conjunction with the accompanying drawings in which:

FIG. 1 is a schematic diagram showing a configuration of waste gas adsorption and recovery system according to an embodiment;

FIG. 2 is a schematic diagram showing a configuration of waste gas treatment device according to an embodiment;

FIG. 3 is a schematic diagram showing a configuration of an adsorption and desorption experiment device;

FIG. 4 is a graph showing results of an adsorption experiment on waste gas using the adsorption and desorption experiment device of FIG. 3;

FIG. 5 is a table showing results of an adsorption experiment on waste gas using the adsorption and desorption experiment device of FIG. 3.

FIG. 6 is a table showing results of an adsorption experiment on waste gas using the adsorption and desorption experiment device of FIG. 3;

FIG. 7 is a table showing results of an adsorption experiment on waste gas using the adsorption and desorption experiment device of FIG. 3;

FIG. 8 is a table showing results of an adsorption experiment on waste gas using the adsorption and desorption experiment device of FIG. 3;

FIG. 9 is a table showing results of an adsorption experiment on waste gas using the adsorption and desorption experiment device of FIG. 3;

FIG. 10 is a table showing results of an adsorption experiment on waste gas using the adsorption and desorption experiment device of FIG. 3;

FIG. 11 is a graph showing results of waste gas break-through experiment using the adsorption and desorption experiment device of FIG. 3; and

FIG. 12 is a table showing results of waste gas break-through experiment using the adsorption and desorption experiment device of FIG. 3.

### DETAILED DESCRIPTION OF THE EMBODIMENTS

Hereinafter, embodiments of the inventive concept will be described in detail with reference to the attached drawings. Like reference numerals are used for like components in the drawings, and duplicate descriptions thereof are omitted.

It will be understood that the terms “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

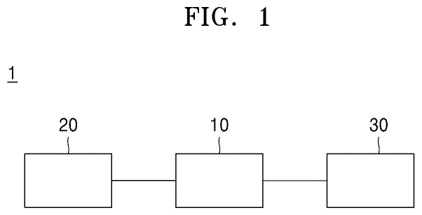

FIG. 1 is a schematic diagram showing a configuration of a waste gas adsorption and recovery system 1 according to an embodiment.

Referring to FIG. 1, the waste gas adsorption and recovery system 1 according to example embodiments may include a waste gas treatment device 10, a semiconductor processing chamber 20, and a recovery unit 30.

In embodiments, the semiconductor processing chamber 20 may be an etch processing chamber. The semiconductor processing chamber 20 may generate waste gas during an etching process. At this point, the waste gas may include at least one gas selected from xenon (Xe), carbon dioxide (CO₂), carbon monoxide (CO), oxygen (O₂), carbon tetrafluoride (CF₄), fluorine (C₂F₆), and sulfur hexafluoride (SF₆), but the waste gas is not limited thereto. The semiconductor processing chamber 20 may be connected to the waste gas treatment device 10 through a pipe. The waste gas may be delivered to the waste gas treatment device 10 through the pipe.

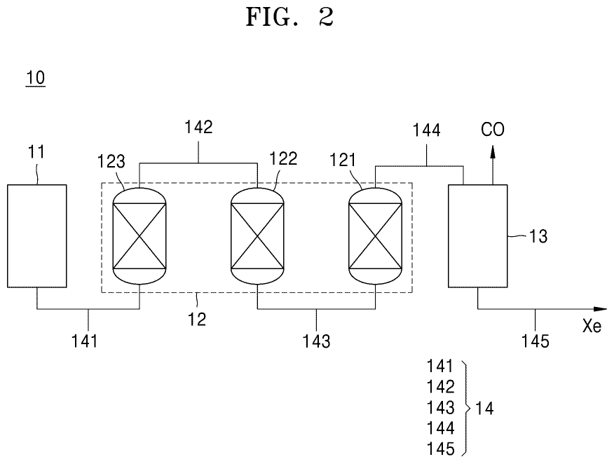

In embodiments, Xe may be selectively recovered from the waste gas delivered to the waste gas treatment device 10. The waste gas treatment device 10 may include an adsorption unit 12 (see FIG. 2) configured to adsorb at least one gas from the waste gas and desorb the adsorbed gas. For example, the waste gas treatment device 10 may selectively adsorb and recover Xe from the waste gas. By way of non-limiting example, the selectively adsorbed and recovered waste gas is at least 98% Xe or at least 99% Xe.

In embodiments, the waste gas treatment device 10 may selectively adsorb and recover Xe using an adsorption tower including an adsorbent including Ag-ZSM-5. A method of selectively adsorbing and recovering Xe using the waste gas treatment device 10 is described in detail with reference to FIG. 2.

In embodiments, the waste gas treatment device 10 may be connected to the recovery unit 30 through a pipe. Xe recovered from waste gas through the waste gas treatment device 10 may be delivered to the recovery unit 30 through the pipe. At this point, the recovery unit 30 may be a cylinder that recovers and stores Xe. Xe recovered in the recovery unit 30 may be purified through a separate process. The purified Xe may be used again in a semiconductor manufacturing process, such as an etching process.

In another embodiment, the recovery unit 30 may be a separate semiconductor processing chamber. For example, Xe recovered from the waste gas through the waste gas treatment device 10 may be directly delivered to the semiconductor processing chamber.

In embodiments, the waste gas adsorption and recovery system 1 of the inventive concept may selectively adsorb and recover Xe from waste gas generated during a semiconductor manufacturing process. By selectively adsorbing and recovering Xe from waste gas, the supply of Xe required for a semiconductor manufacturing process may be facilitated. In addition, there is an effect of reducing semiconductor manufacturing process costs by selectively adsorbing and recovering Xe in waste gas.

FIG. 2 is a schematic diagram showing a configuration of the waste gas treatment device 10 according to an embodiment.

Referring to FIG. 2, the waste gas treatment device 10 according to example embodiments may include a waste gas inlet 11, an adsorption unit 12, a distillation tower 13, and an exhaust line 14, which exhaust line may be indicated by subparts of the line (e.g. 141, 142, 143, 144, and 145 in FIG. 2, which may be denoted as a first exhaust line 141,).

In embodiments, the waste gas inlet 11 may introduce waste gas discharged from the semiconductor processing chamber 20 (see FIG. 1). At this point, the waste gas may include at least one gas selected from Xe, CO₂, CO, O₂, CF₄, C₂F₆, and SF₆, but the waste gas is not limited thereto. The waste gas may flow into the waste gas inlet 11 through a pipe.

In embodiments, the waste gas flowing into the waste gas inlet 11 may be delivered to the adsorption unit 12 through a first exhaust line 141. The adsorption unit 12 may be configured to adsorb Xe from the waste gas flowing in from the waste gas inlet 11 and recover the adsorbed Xe.

In embodiments, the adsorption unit 12 may include a plurality of adsorption towers. For example, the adsorption unit 12 may include a first adsorption tower 121, a second adsorption tower 122, and a third adsorption tower 123. The adsorption towers are not numbered in the order in which the waste gas passes through the tower, but are numbered for identification purposes. According to example embodiments, the adsorption unit may include one or more first adsorption towers and one or more second adsorption towers. The present invention may also include one or more third adsorption towers.

Herein, the terms indicating order, such as first, second, etc., are used to distinguish elements having the same/similar functions, and the ordinal numbers may be interchanged according to the order in which the terms are mentioned. It will be understood that, although the terms first, second, third etc. may be used herein to describe various elements such as adsorption towers and exhaust lines, these elements should not be limited by these terms. Unless the context indicates otherwise, these terms are only used to distinguish one element from another element, for example as a naming convention. In embodiments, the first adsorption tower 121 may be configured to selectively adsorb Xe in waste gas. The first adsorption tower 121 may include an adsorbent including Ag-ZSM-5. Ag-ZSM-5 may be ZSM-5 in which Ag is ion-exchanged. As described herein, in the case of the adsorbent including Ag-ZSM-5, competitive adsorption may occur for other components (e.g., at least one of CO₂, CO, O₂, CF₄, C₂F₆, and SF₆) mixed in the waste gas composition, and there is an effect of selectively adsorbing Xe. Although FIG. 2 shows one first adsorption tower 121, the inventive concept is not limited thereto, and the adsorption unit 12 may include two or more first adsorption towers 121.

In embodiments, such as depicted in FIG. 2, the third adsorption tower 123 and the second adsorption tower 122 may be disposed in front of the first adsorption tower 121 in the adsorption unit 12. The third adsorption tower 123 may be configured for example, to adsorb HF in the waste gas. For example, the third adsorption tower 123 may include an adsorbent including NaF to adsorb HF. According to example embodiments, the adsorption unit further includes a third adsorption tower including an adsorbent including NaF, in which the device is configured in the following order in series: the waste gas inlet, the third adsorption tower, one or more second adsorption towers, and one or more first adsorption towers.

In embodiments, the third adsorption tower 123 may be connected to the waste gas inlet 11 through the first exhaust line 141. The third adsorption tower 123 may adsorb and separate HF from the waste gas flowing in from the waste gas inlet 11 through the first exhaust line 141. By adsorbing and separating highly reactive HF at a front end of the adsorption unit 12, the stability of the waste gas treatment device 10 of the inventive concept may be improved. In addition, in the case of HF, because HF is a substance that reduces the adsorption performance of the adsorbent including Ag-ZSM-5, by adsorbing and separating HF at the front end of the adsorption unit 12, the adsorption performance of the waste gas treatment device 10 may be improved.

In embodiments, the second adsorption tower 122 may be disposed between the first adsorption tower 121 and the third adsorption tower 123. At this point, the first adsorption tower 121, the second adsorption tower 122, and the third adsorption tower 123 may be connected to one another in series. The third adsorption tower 123 and the second adsorption tower 122 are connected through a second exhaust line 142, and the second adsorption tower 122 and the first adsorption tower 121 are connected through a third exhaust line 143.

In embodiments, the second adsorption tower 122 may be disposed in front of the first adsorption tower 121 of the adsorption unit 12. The second adsorption tower 122 may be configured to adsorb competitive adsorption gases in the waste gas. At this point, competitive adsorption gas may refer to gases other than Xe in the waste gas.

In embodiments, the second adsorption tower 122 is disposed in front of the first adsorption tower 121, with respect to the direction of waste gas flow, and thus, the competitive adsorption gases in the waste gas flowing into the waste gas inlet 11 may be separated before Xe is separated in the present processes and systems. For example, the second adsorption tower 122 may adsorb and separate water (H₂O), CO₂, CF₄, C₂F₆, and SF₆ in the waste gas flowing in from the third absorption tower 123 through the second exhaust line 142.

In embodiments, a plurality of second adsorption towers 122 may be present. The plurality of second adsorption towers 122 may each be configured to adsorb different gases. For example, the plurality of second adsorption towers 122 may each include different types of adsorbents. The plurality of second adsorption towers 122 may each include at least one adsorbent selected from MS 5A, ZSM-5, 13X, CaX, and LiX, or a combination thereof. At this point, the plurality of second adsorption towers 122 may be connected in series. The number of second adsorption towers 122 and the type of adsorbent included in each second adsorption tower 122 may be designed in various ways according to need.

In embodiments, waste gas that has passed through the third adsorption tower 123 and the second adsorption tower 122 may flow into the first adsorption tower 121 through the third exhaust line 143. At this point, the waste gas flowing into the first absorption tower 121 may include nitrogen (N₂), O₂, CO, and Xe. The first adsorption tower 121 may be configured to selectively adsorb Xe in the waste gas. The first adsorption tower 121 may include an adsorbent including Ag-ZSM-5. Xe with a purity of about 99% separated through the first adsorption tower 121 may be selectively adsorbed and separated.

In embodiments, the adsorbent of the first adsorption tower 121 may be saturated by adsorbing Xe in the waste gas. At this point, by injecting N₂ into the first adsorption tower 121, Xe may be desorbed and separated from the saturated adsorbent.

In embodiments, by injecting waste gas including N₂ and Xe into the first adsorption tower 121, Xe may be adsorbed and desorbed from the adsorbent in the first adsorption tower 121. The operation of adsorbing Xe and the operation of desorbing the adsorbed Xe, using the first adsorption tower 121, may be repeatedly performed.

In embodiments, the adsorption and desorption of Xe may be repeatedly performed using the first adsorption tower 121, and the adsorbent including Ag-ZSM-5 may be repeatedly used through regeneration. By reusing the adsorbent through regeneration, the adsorption and desorption of Xe may be repeatedly performed without replacing the adsorbent in the first adsorption tower 121 through separate equipment and processes. Accordingly, the cost of the adsorption and recovery procedure of Xe using an adsorbent may be reduced.

In embodiments, a distillation tower 13 may be disposed at a later stage in the processes and systems than the first adsorption tower 121 of the waste gas treatment device 10. In non-limiting embodiments, the present devices may be configured in the following order in series: the waste gas inlet, the adsorption unit, and the distillation tower. The distillation tower 13 may be connected to the first adsorption tower 121 through a fourth exhaust line 144. The waste gas treatment device 10 of the inventive concept may separate carbon monoxide (CO) from gas including Xe supplied through the fourth exhaust line 144 using the distillation tower 13.

In embodiments, the distillation tower 13 may separate CO from gas including Xe introduced through the fourth exhaust line 144 and selectively recover Xe. The distillation tower 13 may separate Xe and CO from the gas supplied through the fourth exhaust line 144 by using a boiling point difference. At this point, the temperature of the distillation tower 13 may be a temperature between the boiling point of Xe (−108.12° C.) and the boiling point of CO (−191.5° C.). For example, the temperature of the distillation tower 13 may be set to about −120° C.

In embodiments, Xe having a purity of about 99.999% recovered through the distillation tower 13 may be recovered through a fifth exhaust line 145 to the recovery unit 30 (see FIG. 1), etc. The fifth exhaust line 145 may connect the distillation tower 13 to the recovery unit 30.

In embodiments, the waste gas treatment device 10 of the inventive concept may selectively adsorb and recover Xe from waste gas generated during a semiconductor manufacturing process. By selectively adsorbing and recovering Xe from waste gas, it is possible to smoothly supply Xe required for the semiconductor manufacturing process. In addition, there is an effect of reducing semiconductor manufacturing process costs by selectively adsorbing and recovering xenon in waste gas.

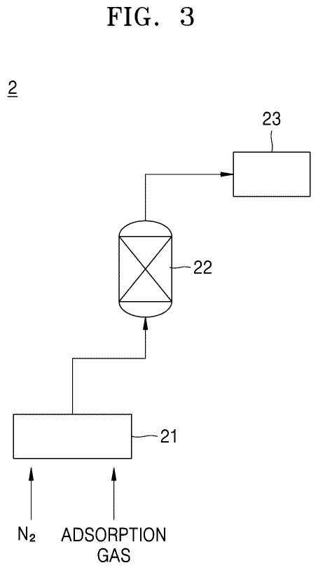

FIG. 3 is a schematic diagram showing a configuration of an adsorption and desorption experiment device 2.

Referring to FIG. 3, the adsorption and desorption experiment device 2 may include a gas inlet 21, an adsorption tower 22, and a gas mass spectrometer (gas MS) 23. The adsorption and desorption experiment device 2 of FIG. 3 may include test equipment that satisfies substantially the same conditions as the waste gas adsorption and recovery system 1 (refer to FIG. 1) and the waste gas treatment device 10 (refer to FIG. 2), respectively, and select an adsorbent that enters the adsorption tower 22.

An adsorption gas and N₂ may be introduced into the gas inlet 21. The adsorption gas and N₂ may constitute waste gas. By injecting the adsorption gas and N₂ into the gas inlet 21, a test may be performed by injecting waste gas having a similar composition to the semiconductor process waste gas into the waste gas treatment device 10 (see FIG. 2) of the inventive concept. In embodiments, the adsorption gas may be configured to include Xe 260 ppm, CO₂ 421 ppm, CO 599 ppm, O₂ 513 ppm, CF₄ 1001 ppm, C₂F₆ 260 ppm, and SF₆ 430 ppm.

The adsorption tower 22 may include an adsorbent including Ag-ZSM-5. Ag-ZSM-5 may be ZSM-5 in which Ag is ion-exchanged. At this point, according to non-limiting example embodiments, 0.5 g of the adsorbent may be mounted on the adsorption tower 22 and activated for 3 hours at a temperature of 250° C. in a nitrogen atmosphere (60 ml/min). Afterwards, under conditions of 25° C. and 1 bar, an adsorption break-through experiment may be performed by flowing waste gas with a composition of Xe 260 ppm, CO₂ 421 ppm, CO 599 ppm, O₂ 513 ppm, CF₄ 1001 ppm, C₂F₆ 260 ppm, and SF₆ 430 ppm in a nitrogen atmosphere at 60 ml/min through the adsorption tower 22 including Ag-ZSM-5 adsorbent.

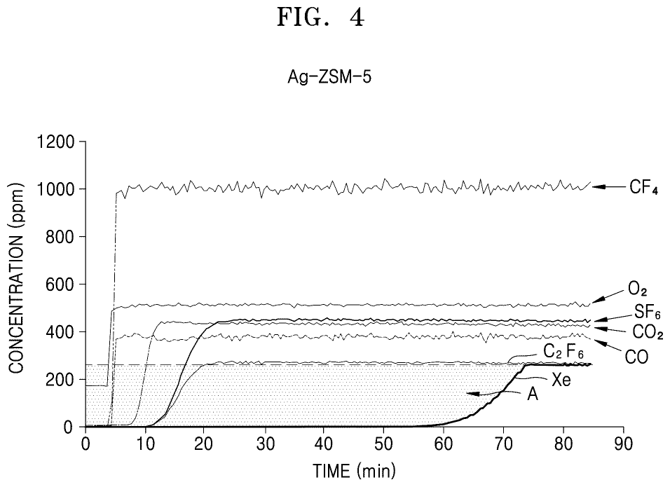

FIGS. 4 to 12 show results of the adsorption and break-through experiments according to the above conditions, such as the adsorption amount of each component and the selectivity of each component relative to Xe. The results of the experiment using the adsorption and desorption experiment device 2 of FIG. 3 will be described in detail herein with reference to FIGS. 4 to 12.

FIG. 4 is a graph showing results of an adsorption experiment on waste gas using the adsorption and desorption experiment device 2 of FIG. 3.

Referring to FIG. 4, a break-through point and break-through time of each component may be confirmed as a result of the adsorption experiment on the waste gas using the adsorption and desorption experiment device 2. At this point, the break-through point refers to a point when the adsorbent reaches the break-through point and the concentration at an inlet and an outlet of the adsorption tower 22 becomes the same, and the time from the point when waste gas begins to flow into the adsorption tower 22 until the waste gas reaches the break-through point may be referred to as a break-through time.

In embodiments, it may be seen that the break-through time of Xe is about 60 minutes. It may be confirmed that the break-through time of Xe on Ag-ZSM-5 adsorbent is large compared to other components (e.g., CO₂, CO, O₂, CF₄, C₂F₆, and SF₆), which reach their break-through point within or around 10 min.

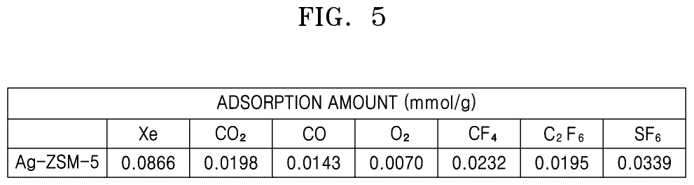

FIG. 5 is a table showing results of an adsorption experiment on waste gas using the adsorption and desorption experiment device 2 of FIG. 3.

Referring to FIG. 5, the adsorption amount of each composition included in the waste gas on the adsorbent may be confirmed. In other words, the adsorption amount of xenon (Xe), CO₂, CO, O₂, CF₄, C₂F₆, and SF₆ on Ag-ZSM-5 may be confirmed. At this point, the adsorption amount may denote the amount of gas adsorbed per 1 g of adsorbent. Additionally, the adsorption amount may be calculated as an area A between each component graph and a Y-axis in the graph of FIG. 5 after break-through is completed.

As a result of the adsorption experiment on waste gas using the adsorption and desorption experiment device 2 (refer to FIG. 3), the amount of Xe adsorbed on Ag-ZSM-5 may be 0.0866 mmol/g. The adsorption amount of CO₂ on Ag-ZSM-5 may be 0.0198 mmol/g. The adsorption amount of CO on Ag-ZSM-5 may be 0.0143 mmol/g. The adsorption amount of O₂ on Ag-ZSM-5 may be 0.0070 mmol/g. The adsorption amount of CF₄ on Ag-ZSM-5 may be 0.0232 mmol/g. The adsorption amount of C₂F₆ on Ag-ZSM-5 may be 0.0195 mmol/g. The adsorption amount of SF₆ on Ag-ZSM-5 may be 0.0339 mmol/g.

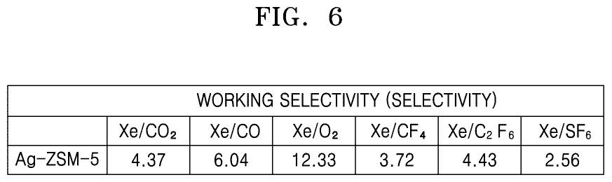

FIG. 6 is a table showing results of an adsorption experiment on waste gas using the adsorption and desorption experiment device 2 of FIG. 3.

Referring to FIG. 6, the selectivity for Xe, of each composition included in the waste gas, may be confirmed. For example, the selectivity of each of CO₂, CO, O₂, CF₄, C₂F₆, and SF₆ to Xe may be confirmed. At this point, selectivity may denote a ratio of an amount adsorbed on the adsorbent (for example, Ag-ZSM-5) for each component compared to Xe.

As a result of an adsorption experiment on waste gas using the adsorption and desorption experiment device 2 (refer to FIG. 3), the selectivity of CO₂ to Xe (e.g., (Xe adsorption amount)/(CO₂ adsorption amount) may be 4.37. The selectivity of CO to Xe (e.g., (Xe adsorption amount)/(CO adsorption amount)) may be 6.04. The selectivity of O₂ to Xe (e.g., (Xe adsorption amount)/(O₂ adsorption amount)) may be 12.33. The selectivity of CF₄ to Xe (e.g., (Xe adsorption amount)/(CF₄ adsorption amount)) may be 3.72. The selectivity of C₂F₆ to Xe (e.g., (Xe adsorption amount)/(C₂F₆ adsorption amount)) may be 4.43. The selectivity of SF₆ to Xe (e.g., (Xe adsorption amount)/(SF₆ adsorption amount)) may be 2.56.

Referring to FIGS. 5 and 6 together, in the case of the adsorbent including Ag-ZSM-5, competitive adsorption for other components mixed in the waste gas composition (e.g., CO₂, CO, O₂, CF₄, C₂F₆, and SF₆) may occur to some extent, but it may be confirmed that the adsorbent including Ag-ZSM-5 exhibits a selective adsorption effect for Xe.

To prevent competitive adsorption between Xe and other components on the adsorbent including Ag-ZSM-5, in the waste gas treatment device 10 (refer to FIG. 2) of the inventive concept, the second adsorption tower 122 and the third adsorption tower 123 are disposed at the front of the first adsorption tower 121, with respect to the direction of waste gas flow, to separate components other than Xe, and thus, a high concentration of Xe may be recovered.

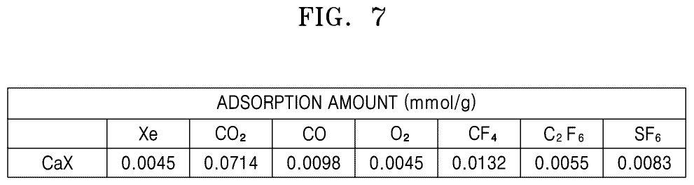

FIG. 7 is a table showing results of an adsorption experiment on waste gas using the adsorption and desorption experiment device 2 of FIG. 3.

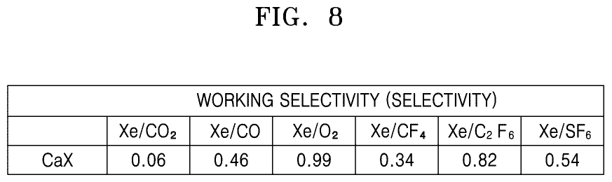

FIG. 8 is a table showing results of an adsorption experiment on waste gas using the adsorption and desorption experiment device 2 of FIG. 3.

FIGS. 7 and 8 are the results of tests that are the same as the test described with reference to FIGS. 4 to 6, except for replacing the adsorbent. In embodiments, the adsorption and desorption experiment device 2 (refer to FIG. 3) is used, but the adsorption tower 22 may include an adsorbent including CaX. CaX may be X-type zeolite (CaX) in which Ca is ion-exchanged. At this point, according to non-limiting example embodiments, the adsorbent of 0.5 g may be mounted on the adsorption tower 22 and activated for 3 hours at 250° C. in a nitrogen atmosphere (60 ml/min). Afterwards, under conditions of 25° C. and 1 bar, an adsorption break-through experiment may be performed by flowing waste gas with a composition of Xe 260 ppm, CO₂ 421 ppm, CO 599 ppm, O₂513 ppm, CF₄ 1001 ppm, C₂F₆ 260 ppm, and SF₆ 430 ppm in a nitrogen atmosphere at 60 ml/min through the adsorption tower 22 including CaX adsorbent.

Referring to FIG. 7, the adsorption amount of each composition included in the waste gas for the adsorbent may be confirmed. The adsorption amounts of Xe, CO₂, CO, O₂, CF₄, C₂F₆, and SF₆ on CaX may be confirmed. At this point, the adsorption amount may denote the amount of gas adsorbed per 1 g of adsorbent.

As a result of an adsorption experiment on waste gas using the adsorption and desorption experiment device 2, the adsorption amount of Xe to CaX may be 0.0045 mmol/g. The adsorption amount of CO₂ on CaX may be 0.0714 mmol/g. The adsorption amount of CO on CaX may be 0.0098 mmol/g. The adsorption amount of 02 on CaX may be 0.0045 mmol/g. The adsorption amount of CF₄ on CaX may be 0.0132 mmol/g. The adsorption amount of C₂F₆ on CaX may be 0.0055 mmol/g. The adsorption amount of SF₆ on CaX may be 0.0083 mmol/g.

Referring to FIG. 8, the selectivity of each composition included in the waste gas for Xe may be confirmed. For example, the selectivity of each of CO₂, CO, O₂, CF₄, C₂F₆, and SF₆ to Xe may be confirmed. At this point, the selectivity may denote a ratio of an amount adsorbed on the adsorbent (for example, CaX) for each component compared to Xe.

As a result of an adsorption experiment on waste gas using the adsorption and desorption experiment device 2, the selectivity of CO₂ to Xe (e.g., (Xe adsorption amount)/(CO₂ adsorption amount)) may be 0.06. The selectivity of CO to Xe (e.g., (Xe adsorption amount)/(CO adsorption amount)) may be 0.46. The selectivity of O₂ to Xe (e.g., (Xe adsorption amount)/(O₂ adsorption amount)) may be 0.99. The selectivity of CF₄ to Xe (e.g., (Xe adsorption amount)/(CF₄ adsorption amount)) may be 0.34. The selectivity of C₂F₆ to Xe (e.g., (Xe adsorption amount)/(C₂F₆ adsorption amount)) may be 0.82. The selectivity of SF₆ to Xe (e.g., (Xe adsorption amount)/(SF₆ adsorption amount)) may be 0.54.

Referring to FIGS. 7 and 8 together, it may be seen that, in the case of an adsorbent including CaX, the amount of adsorption of CO₂ is selectively high. In addition, it may be confirmed that, in the case of an adsorbent including CaX, Xe is hardly adsorbed. Accordingly, CO₂ may be selectively removed by placing the second adsorption tower 122 (refer to FIG. 2) including an adsorbent including CaX in front of the first adsorption tower 121 (refer to FIG. 2).

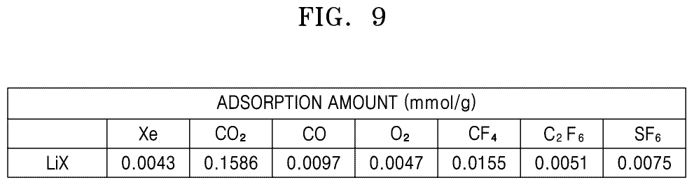

FIG. 9 is a table showing results of an adsorption experiment on waste gas using the adsorption and desorption experiment device 2 of FIG. 3.

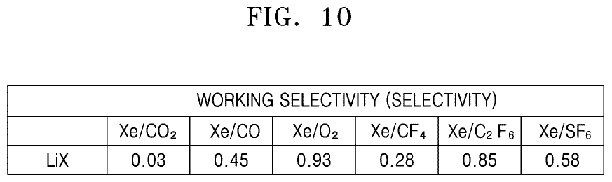

FIG. 10 is a table showing results of an adsorption experiment on waste gas using the adsorption and desorption experiment device 2 of FIG. 3.

FIGS. 9 and 10 show the results of a test that is entirely the same as the test described with reference to FIGS. 4 to 6, except for replacing the adsorbent. In embodiments, the adsorption and desorption experiment device 2 (refer to FIG. 3) is used, but the adsorption tower 22 may include an adsorbent including LiX. LiX may be an X-type zeolite (LiX) in which Li is ion-exchanged. At this point, according to non-limiting example embodiments, the adsorbent of 0.5 g may be mounted on the adsorption tower 22 and activated for 3 hours at 250° C. in a nitrogen atmosphere (60 ml/min). Afterwards, under conditions of 25° C. and 1 bar, an adsorption break-through experiment may be performed by flowing waste gas with a composition of Xe 260 ppm, CO₂ 421 ppm, CO 599 ppm, O₂ 513 ppm, CF₄ 1001 ppm, C₂F₆ 260 ppm, and SF₆ 430 ppm in an N₂ atmosphere at 60 ml/min through the adsorption tower 22 including LiX adsorbent.

Referring to FIG. 9, the adsorption amount of each component included in the waste gas for the adsorbent may be confirmed. In other words, the adsorption amounts of Xe, CO₂, CO, O₂, CF₄, C₂F₆, and SF₆ on CaX may be confirmed. At this point, the adsorption amount may denote the amount of gas adsorbed per 1 g of adsorbent.

As a result of an adsorption experiment on waste gas using the adsorption and desorption experiment device 2, the adsorption amount of Xe to LiX may be 0.0043 mmol/g. The adsorption amount of CO₂ on LiX may be 0.1586 mmol/g. The adsorption amount of CO on LiX may be 0.0097 mmol/g. The adsorption amount of O₂ on LiX may be 0.0047 mmol/g. The adsorption amount of CF₄ on LiX may be 0.0155 mmol/g. The adsorption amount of C₂F₆ on LiX may be 0.0051 mmol/g. The adsorption amount of SF₆ on LiX may be 0.0075 mmol/g.

Referring to FIG. 8, the selectivity of each composition included in the waste gas for Xe may be confirmed. For example, the selectivity of CO₂, CO, O₂, CF₄, C₂F₆, and SF₆ for Xe may be confirmed. At this point, selectivity may denote a ratio of an amount adsorbed on the adsorbent (for example, LiX) for each component compared to Xe.

As a result of an adsorption experiment on waste gas using the adsorption and desorption experiment device 2, the selectivity of CO₂ to Xe (e.g., (Xe adsorption amount)/(CO₂ adsorption amount)) may be 0.03. The selectivity of CO to Xe (e.g., (Xe adsorption amount)/(CO adsorption amount)) may be 0.45. The selectivity of O₂ to Xe (e.g., (Xe adsorption amount)/(O₂ adsorption amount)) may be 0.93. The selectivity of CF₄ to Xe (e.g., (Xe adsorption amount)/(CF₄ adsorption amount)) may be 0.28. The selectivity of C₂F₆ to Xe (e.g., (Xe adsorption amount)/(C₂F₆ adsorption amount)) may be 0.85. The selectivity of SF₆ to Xe (e.g., (Xe adsorption amount)/(SF₆ adsorption amount)) may be 0.58.

Referring to FIGS. 9 and 10 together, it may be seen that, in the case of an adsorbent including LiX, the amount of adsorption of CO₂ is selectively high. In particular, in the case of the adsorbent including LiX, it may be confirmed that the amount of CO₂ adsorbed is greater than that of the adsorbent including CaX. In addition, in the case of an adsorbent including LiX, it may be confirmed that Xe is hardly adsorbed. Accordingly, CO₂ may be selectively removed by placing the second adsorption tower 122 (refer to FIG. 2) including an adsorbent including CaX in front of the first adsorption tower 121 (refer to FIG. 2).

Referring to FIGS. 4 to 10, it may be seen that, among various adsorbents, Ag-ZSM-5, which is ZSM-5 in which Ag is ion-exchanged, has a high adsorption rate for Xe. Therefore, by using the adsorbent including Ag-ZSM-5 in the first adsorption tower 121 and by placing the second adsorption tower 122 and the third adsorption tower 123 in front of the first adsorption tower 121, with respect to the direction of waste gas flow, it is possible to prevent competitive adsorption between Xe and other components of the waste gas from occurring within the first adsorption tower 121.

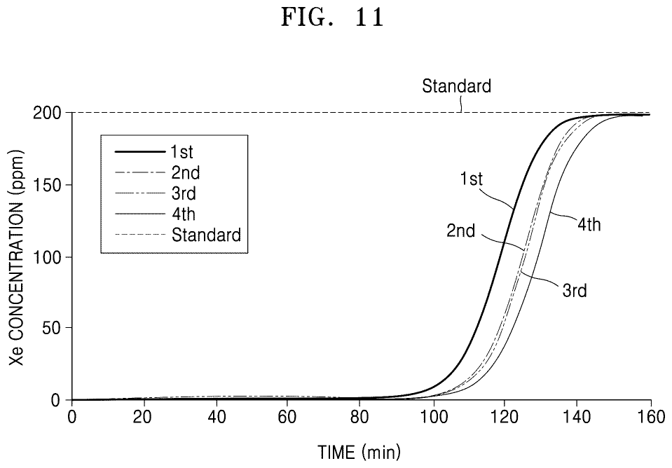

FIG. 11 is a graph showing results of a waste gas break-through experiment using the adsorption and desorption experiment device 2 of FIG. 3.

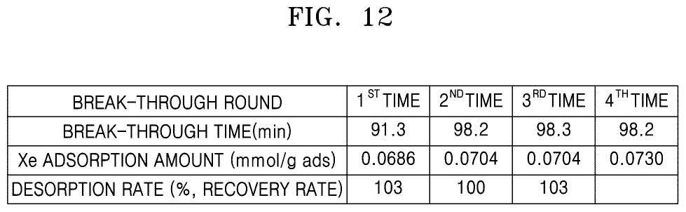

FIG. 12 is a table showing the results of a waste gas break-through experiment using the adsorption and desorption experiment device 2 of FIG. 3.

In FIGS. 11 and 12, the adsorption tower 22 (refer to FIG. 2) may include an adsorbent including Ag-ZSM-5. Ag-ZSM-5 may be ZSM-5 in which Ag is ion-exchanged. At this point, the adsorbent of 1 g may be mounted on the adsorption tower 22 and activated for 3 hours at 250° C. in a nitrogen atmosphere (60 ml/min). Afterwards, under conditions of 25° C. and 1 bar, an adsorption break-through experiment may be performed by flowing waste gas with a composition of Xe 200 ppm in a nitrogen atmosphere into the adsorption tower 22 including Ag-ZSM-5 as the adsorbent. After the break-through is completed, the temperature is set to 250° C. to be the same as the initial activation temperature, the adsorbent is regenerated by reactivating for 3 hours, and an adsorption break-through may be performed under the same conditions. The above method is repeated up to four times to confirm the regeneration of the adsorbent by repeating the adsorption-desorption cycle.

Referring to FIGS. 11 and 12, it may be confirmed that the break-through time and desorption rate are not significantly changed even though the break-through rounds are repeated. Because the adsorption performance does not deteriorate even if the break-through cycle is repeated, the adsorbent including Ag-ZSM-5 may be repeatedly used through regeneration. At this point, the desorption rate may be calculated as ((adsorption amount for next round)/(adsorption amount for previous round))*100.

In embodiments, by reusing the adsorbent through regeneration, adsorption and desorption of Xe may be repeatedly performed without replacing the adsorbent through separate equipment and processes. Accordingly, the cost of the adsorption and recovery procedure of Xe using an adsorbent may be reduced.

While the inventive concept has been particularly shown and described with reference to embodiments thereof, it will be understood that various changes in form and details may be made therein without departing from the spirit and scope of the following claims.

What is claimed is:

1. A waste gas treatment device comprising:
a waste gas inlet configured to introduce waste gas discharged from a semiconductor processing chamber; and
an adsorption unit configured to adsorb competitive adsorption gas from the waste gas flowing from the waste gas inlet, and configured to adsorb xenon (Xe) from the waste gas from which the competitive adsorption gas has been removed, and recover the adsorbed xenon.

2. The waste gas treatment device of claim 1, wherein
the adsorption unit includes one or more first adsorption towers configured to selectively adsorb xenon from the waste gas.

3. The waste gas treatment device of claim 2, wherein the one or more first adsorption towers include an adsorbent including Ag-ZSM-5.

4. The waste gas treatment device of claim 2, wherein
the adsorption unit further comprises one or more second adsorption towers configured to adsorb the competitive adsorption gas from the waste gas.

5. The waste gas treatment device of claim 4, wherein
the device is configured in the following order in series: waste gas inlet one or more second adsorption towers, and one or more first absorption towers.

6. The waste gas treatment device of claim 4, wherein
the one or more second adsorption towers include a plurality of adsorption towers configured to adsorb different competitive adsorption gases,
wherein the plurality of adsorption towers are in series and connected to one another.

7. The waste gas treatment device of claim 4, wherein
the one or more second adsorption towers include at least one adsorbent selected from the group consisting of MS 5A, ZSM-5, 13X, CaX, and LiX.

8. The waste gas treatment device of claim 1, further comprising a distillation tower, wherein the device is configured in the following order in series: the waste gas inlet, the adsorption unit, and the distillation tower.

9. The waste gas treatment device of claim 4, wherein
the adsorption unit further includes a third adsorption tower including an adsorbent including NaF, wherein the device is configured in the following order in series: the waste gas inlet, the third adsorption tower, the one or more second adsorption towers, and the one or more first adsorption towers.

10. A waste gas treatment method comprising:
introducing waste gas discharged from a semiconductor processing chamber, into an adsorption unit of a waste gas treatment device, wherein the adsorption unit comprises one or more first adsorption towers and one or more second adsorption towers;
adsorbing competitive adsorption gas from the waste gas introduced into the adsorption unit, in the one or more second adsorption towers;
adsorbing xenon (Xe) from the waste gas from which the competitive adsorption gas is removed, in the one or more first adsorption towers; and
desorbing the adsorbed Xe by injecting nitrogen into the one or more first adsorption towers.

11. The waste gas treatment method of claim 10, wherein
the competitive adsorption gas comprises at least one gas selected from the group consisting of carbon dioxide (CO₂), carbon monoxide (CO), oxygen (O₂), carbon tetrafluoride (CF₄), fluorine (C₂F₆), and sulfur hexafluoride (SF₆).

12. The waste gas treatment method of claim 11, wherein the adsorption unit further comprises a third adsorption tower including an adsorbent including NaF.

13. The waste gas treatment method of claim 10, further comprising distilling the desorbed Xe using a distillation tower.

14. The waste gas treatment method of claim 10, wherein the one or more first adsorption towers include an adsorbent including Ag-ZSM-5.

15. The waste gas treatment method of claim 10, wherein
the adsorbing of Xe and the desorbing of the adsorbed Xe, using the one or more first adsorption towers, are performed repeatedly.

16. A waste gas adsorption and recovery system comprising:
a semiconductor processing chamber;
a waste gas treatment device including a waste gas inlet configured to introduce waste gas discharged from the semiconductor processing chamber and an adsorption unit configured to adsorb competitive adsorption gas from the waste gas flowing from the waste gas inlet, and configured to adsorb xenon (Xe) from the waste gas from which the competitive adsorption gas has been removed, and desorb adsorbed xenon; and
a recovery unit configured to recover xenon desorbed from the waste gas treatment device,
wherein the adsorption unit includes one or more first adsorption towers configured to selectively adsorb Xe from the waste gas and to desorb the adsorbed xenon, and
wherein the one or more first adsorption towers include an adsorbent including Ag-ZSM-5.

17. The waste gas adsorption and recovery system of claim 16, wherein
the adsorption unit further includes one or more second adsorption towers configured to adsorb competitive adsorption gas other than Xe in the waste gas.

18. The waste gas adsorption and recovery system of claim 17, wherein
the waste gas treatment device is configured in the following order in series: waste gas inlet, one or more second adsorption towers, and one or more first absorption towers.

19. The waste gas adsorption and recovery system of claim 17, wherein
the one or more second adsorption towers include a plurality of adsorption towers configured to adsorb different competitive adsorption gas, and the plurality of adsorption towers are in series.

20. The waste gas adsorption and recovery system of claim 16, wherein
the waste gas treatment device further includes a distillation tower, wherein the device is configured in the following order in series: the waste gas inlet, the adsorption unit, and the distillation tower.
